(19) United States
(12) Patent Application Publication
(10) Pub. No.: US 2025/0231443 A1
(43) Pub. Date: Jul. 17, 2025

(54) LIQUID CRYSTAL OPTICAL DEVICE AND ELECTRONIC PRODUCT

(71) Applicant: CHENGDU YETA TECHNOLOGY CO., LTD., Chengdu (CN)

(72) Inventors: Mao YE, Chengdu (CN); Wenbin FENG, Chengdu (CN); Bin WANG, Chengdu (CN)

(73) Assignee: CHENGDU YETA TECHNOLOGY CO., LTD., Chengdu (CN)

(21) Appl. No.: 19/017,819

(22) Filed: Jan. 13, 2025

(30) Foreign Application Priority Data
Jan. 15, 2024 (CN) 202410056761.2
Mar. 25, 2024 (CN) 202410346481.5

(51) Int. Cl. G02F 1/1343; G02F 1/1335

(52) U.S. Cl. CPC G02F 1/134309; G02F 1/133526; G02F 1/13439

(57) ABSTRACT

A liquid crystal optical device and an electronic product are provided. The liquid crystal optical device provided by this invention includes a first substrate, a first electrode layer, a liquid crystal layer, a second electrode layer, and a second substrate sequentially stacked. The second electrode layer comprises an insulating layer, a first electrode structure, and a second electrode structure. One of the first electrode structure and the second electrode structure is located on the side of the insulating layer facing the liquid crystal layer, while the other is located on the side of the insulating layer away from the liquid crystal layer. The projection of the second electrode structure onto the plane of the first electrode structure covers the gaps in the first electrode structure. This invention effectively eliminates the diffraction phenomenon in liquid crystal optical devices.

### FIELD OF INVENTION

The present invention belongs to the field of liquid crystal optical device, specifically relating to a liquid crystal optical device and an electronic product.

### DESCRIPTION OF RELATED ARTS

To improve the spatial potential distribution precision of liquid crystal optical devices such as liquid crystal lenses and liquid crystal Fresnel lenses, the applicant has proposed the use of electrode wires capable of generating gradient potential distributions arranged within the liquid crystal optical device. By controlling the positions of the electrode wires in the functional region of the liquid crystal optical device, the spatial potential distribution in this region can be precisely controlled. However, adopting this structure introduces diffraction phenomena that adversely affect the optical performance of refractive liquid crystal optical devices.

### SUMMARY OF THE PRESENT INVENTION

In view of the above, embodiments of the present invention provide a liquid crystal optical device and an electronic product to address the technical issue of significant diffraction phenomena in existing refractive liquid crystal optical devices.

The technical solutions adopted by the present invention are as follows:

In a first aspect, the present invention provides a liquid crystal optical device comprising a first substrate, a first electrode layer, a liquid crystal layer, a second electrode layer, and a second substrate, sequentially stacked.

In a second aspect, the present invention provides an electronic product comprising a control circuit and the liquid crystal optical device described in the first aspect, wherein the control circuit is electrically connected to the liquid crystal optical device.

### Beneficial Effect

The liquid crystal optical device and electronic product of the present invention incorporate two electrode structures, namely the first electrode structure and the second electrode structure, within the second electrode layer to control the spatial electric field distribution in the liquid crystal optical device. An insulating layer separates the two electrode structures, ensuring mutual insulation. The second electrode structure's projection on the plane of the first electrode structure covers the gaps between adjacent segments of the first electrode structure. Similarly, the first electrode structure's projection on the plane of the second electrode structure covers the gaps between adjacent segments of the second electrode structure. This arrangement effectively eliminates the diffraction phenomena caused by a single electrode structure when a driving voltage is applied, thereby significantly improving the optical performance of the liquid crystal optical device.

### BRIEF DESCRIPTION OF THE DRAWINGS

To provide a clearer understanding of the technical embodiments of the present invention, the following brief descriptions of the accompanying drawings used in the embodiments will be provided. It should be understood by those skilled in the art that, without exerting any creative effort, additional drawings can be derived based on these drawings, and all such variations are within the scope of the present invention.

FIG. 1 is an exploded structural diagram of the liquid crystal optical device according to the present invention;

FIG. 2 is a cross-sectional view of the liquid crystal optical device according to the present invention.

FIG. 3 is a schematic diagram of the first electrode structure in a concentric arc shape according to the first embodiment of the present invention.

FIG. 4 is a schematic diagram of the second electrode structure in a concentric arc shape according to the first embodiment of the present invention.

FIG. 5 is a schematic diagram of overlapping projections of the first and second electrode structures in a concentric arc shape according to the first embodiment of the present invention.

FIG. 6 is a schematic diagram of the first electrode structure in a concentric arc shape according to the second embodiment of the present invention.

FIG. 7 is a schematic diagram of the second electrode structure in a concentric arc shape according to the second embodiment of the present invention.

FIG. 8 is a schematic diagram of overlapping projections of the first and second electrode structures in a concentric arc shape according to the second embodiment of the present invention.

FIG. 9 is a schematic diagram of the first electrode structure with the first potential distribution wire in the present invention.

FIG. 10 is a schematic diagram of the second electrode structure with the second potential distribution wire in the present invention.

FIG. 11 is a schematic diagram of overlapping third and fourth electrode wires in the present invention.

FIG. 12 is a schematic diagram of another first electrode structure with the first potential distribution wire in the present invention.

FIG. 13 is a schematic diagram of another second electrode structure with the second potential distribution wire in the present invention.

FIG. 14 is a schematic diagram of partially overlapping third and fourth electrode wires in the present invention.

FIG. 15 is a schematic diagram of another partially overlapping third and fourth electrode wires in the present invention.

FIG. 16 is a schematic diagram of the second electrode structure with the third potential distribution wire in the present invention.

FIG. 17 is a schematic diagram of the second electrode structure with the fourth potential distribution wire in the present invention.

FIG. 18 is a schematic diagram of overlapping first and second electrode structures in FIGS. 16 and 17 of the present invention.

FIG. 19 is a schematic diagram of another second electrode structure with the third potential distribution wire in the present invention.

FIG. 20 is a schematic diagram of another second electrode structure with the fourth potential distribution wire in the present invention.

FIG. 21 is a schematic diagram of overlapping first and second electrode structures in FIGS. 19 and 20 of the present invention.

FIG. 22 is a schematic diagram of another overlapping first and second electrode structures in FIGS. 19 and 20 of the present invention.

FIG. 23 is a schematic diagram of the first electrode structure of the Fresnel liquid crystal lens in the present invention.

FIG. 24 is a schematic diagram of the second electrode structure of the Fresnel liquid crystal lens in the present invention.

FIG. 25 is a schematic diagram of overlapping first and second electrode structures in FIGS. 23 and 24 of the present invention.

FIG. 26 is a schematic diagram of another overlapping first and second electrode structures in FIGS. 23 and 24 of the present invention.

FIG. 27 is a schematic diagram of the potential distribution when the second electrode layer adopts a single electrode structure in prior art.

FIG. 28 is a schematic diagram of the potential distribution when one of the two electrode structures in the present invention is loaded with a driving voltage, and the other is not.

FIG. 29 is a schematic diagram of the potential distribution when both electrode structures in the present invention are loaded with driving voltages.

FIG. 30 is a cross-sectional view of the liquid crystal optical device according to the present invention.

FIG. 31 is a schematic diagram of the first type of electrode unit with a concentric arc shape in the present invention.

FIG. 32 is a structural diagram of the first electrode structure of the electrode unit in the present invention.

FIG. 33 is a structural diagram of the second electrode structure of the electrode unit in the present invention.

FIG. 34 is a structural diagram of the second type of electrode unit with a concentric arc shape in the present invention.

FIG. 35 is a structural diagram of the third type of electrode unit with a concentric arc shape in the present invention.

FIG. 36 is a structural diagram of the first type of electrode unit implementing a liquid crystal cylindrical lens in the present invention.

FIG. 37 is a structural diagram of the second type of electrode unit implementing a liquid crystal cylindrical lens in the present invention.

FIG. 38 is a structural diagram of the third type of electrode unit implementing a liquid crystal cylindrical lens in the present invention.

FIG. 39 is a schematic diagram of the first type of electrode unit implementing a Fresnel liquid crystal lens in the present invention.

FIG. 40 is a schematic diagram of the second type of electrode unit implementing a Fresnel liquid crystal lens in the present invention.

The accompanying drawings are labeled as follows:

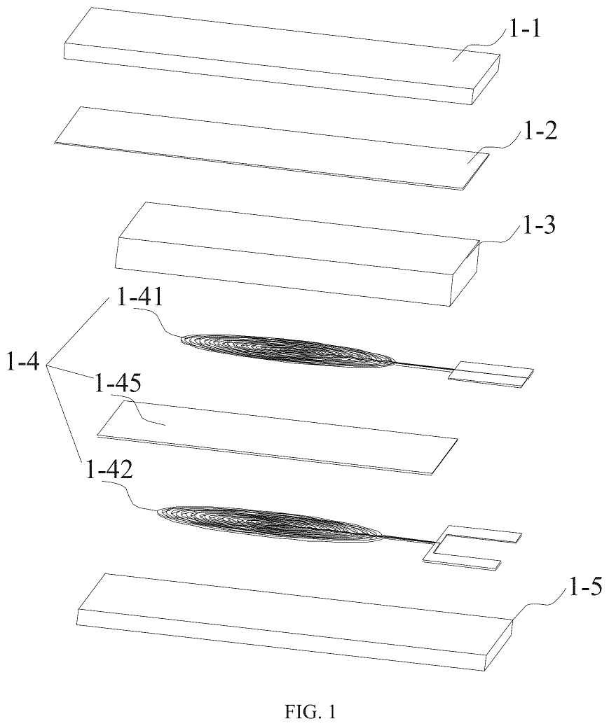

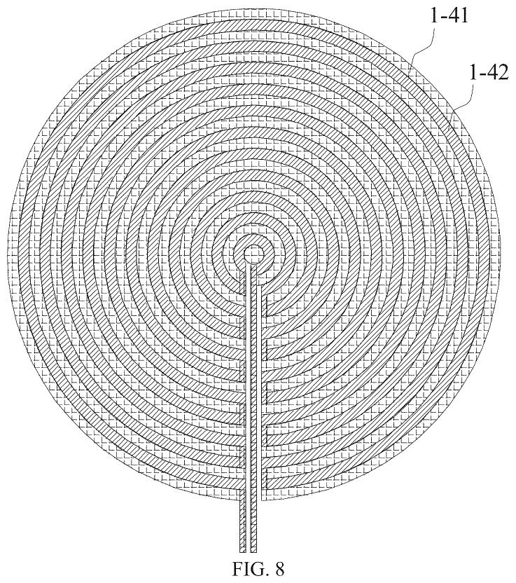

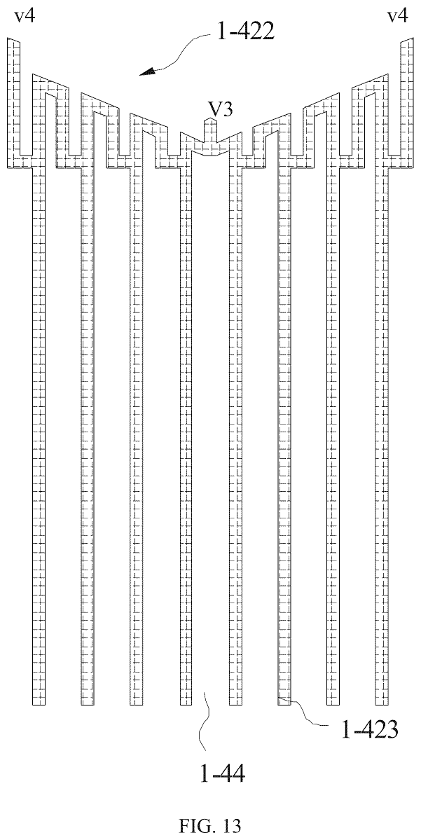

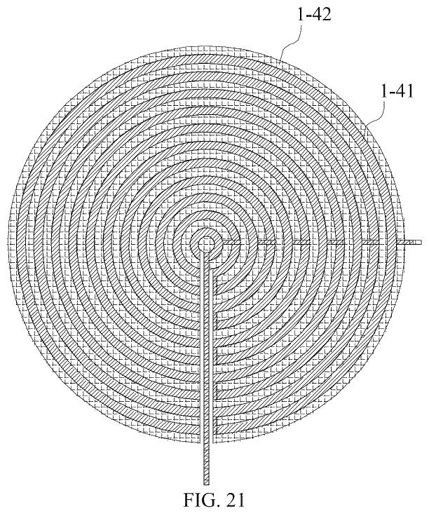

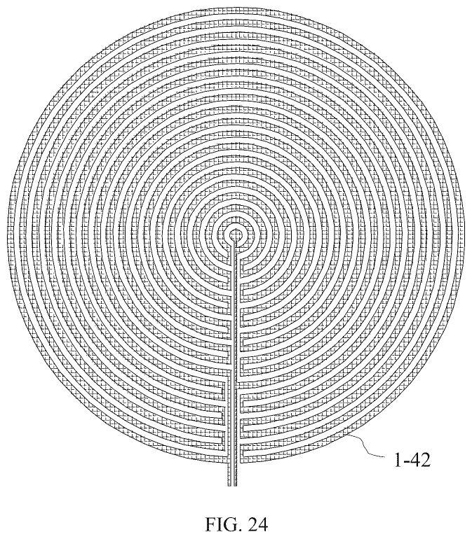

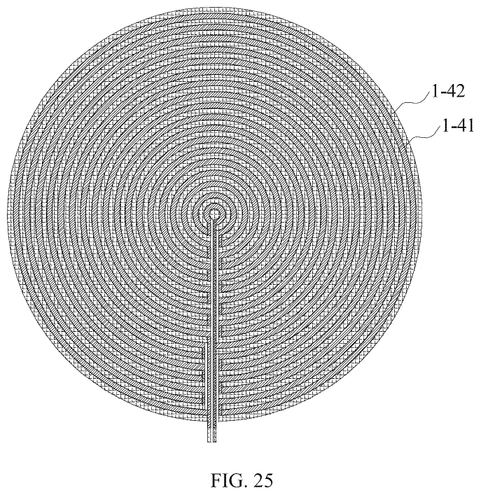

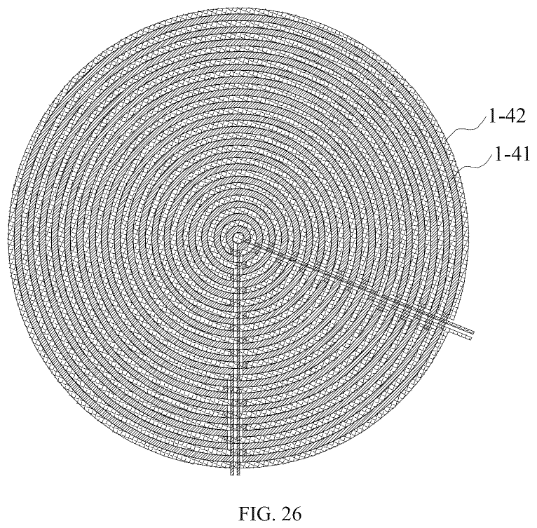

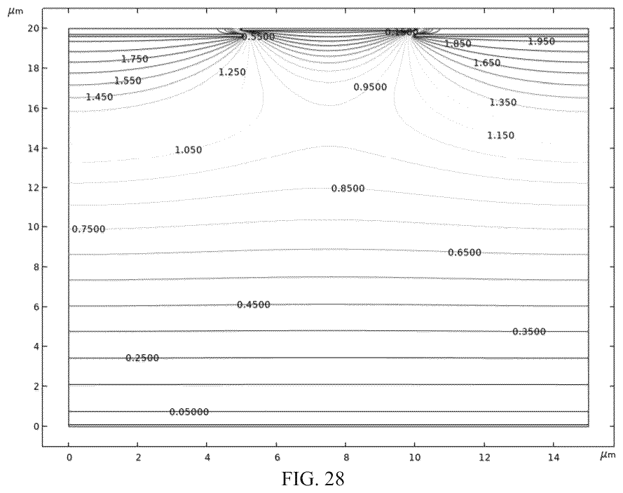

Parts and Numbers in FIGS. 1-29:
First substrate: 1-1
First electrode layer: 1-2
Liquid crystal layer: 1-3
Second electrode layer: 1-4 First electrode structure: 1-41
First electrode wire: 1-411
First potential distribution wire: 1-412
Third electrode wire: 1-413
Third potential distribution wire: 1-414
Second electrode structure: 1-42
Second electrode wire: 1-421
Second potential distribution wire: 1-422
Fourth electrode wire: 1-423
Fourth potential distribution wire: 1-424
Concentric arc segment: 1-431
Connection segment: 1-432
Gap: 1-44
Insulating layer: 1-45
Concentric arc electrode wire: 1-46
Second substrate: 1-5

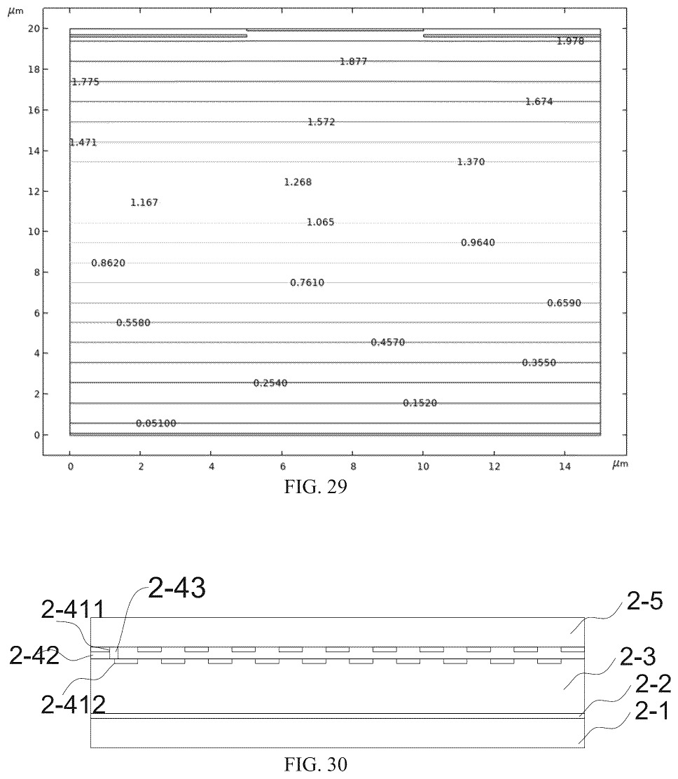

Parts and Numbers in FIGS. 30-40:
First substrate: 2-1
First electrode layer: 2-2
Liquid crystal layer: 2-3
Second electrode layer: 2-4
Electrode unit: 2-41
First electrode structure: 2-411
Second electrode structure: 2-412
Electrode wire: 2-431
First insulating layer: 2-42
Through hole: 2-43
Concentric arc segment: 2-44
potential distribution wire: 2-45
Gap: 2-47
First electrode lead: 2-491
Second electrode lead: 2-492
Second substrate: 2-5

### DETAILED DESCRIPTION

### Embodiment 1

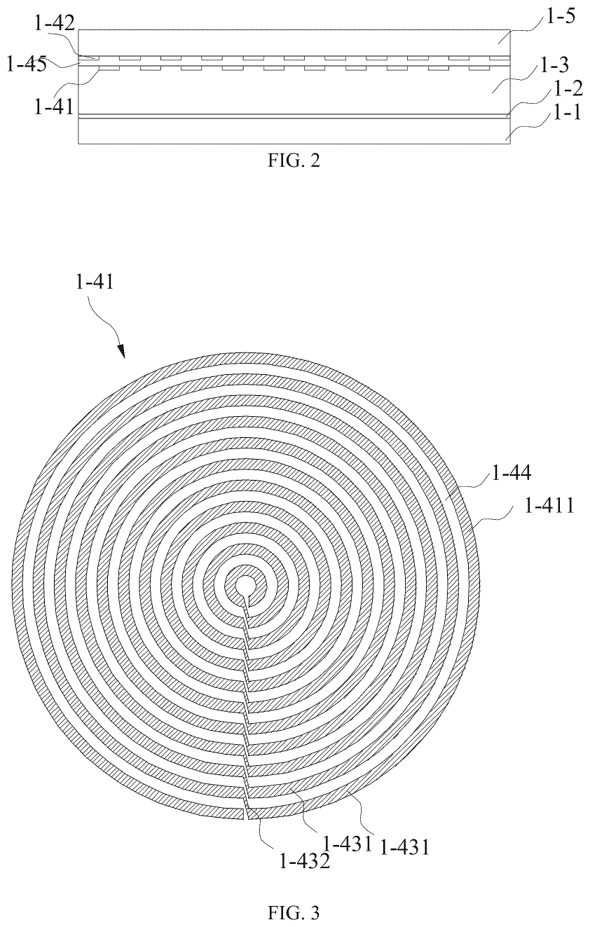

As shown in FIGS. 1 and 2, this embodiment provides a liquid crystal optical device primarily comprising sequentially stacked a first substrate (1-1), a first electrode layer (1-2), a liquid crystal layer (1-3), a second electrode layer (1-4), and a second substrate (1-5).

In this embodiment, the liquid crystal optical device adopts a layered arrangement structure. The first substrate (1-1), first electrode layer (1-2), liquid crystal layer (1-3), second electrode layer (1-4), and second substrate (1-5) are stacked along the normal direction of each layer of the liquid crystal optical device.

The first and second transparent substrates can be made of transparent materials with certain strength and rigidity, such as glass substrates or plastic substrates. The first substrate (1-1) serves to support the liquid crystal optical device and can act as a carrier for the first electrode layer (1-2), which may be coated onto the first substrate (1-1). Similarly, the second substrate (1-5) provides support and can act as a carrier for the second electrode layer (1-4).

The third electrode structure within the first electrode layer can be configured as needed. For instance, it may be set as a planar electrode, enabling the first electrode layer (1-2) to form an equipotential plane. Alternatively, it can take the form of various patterned electrodes, with no restrictions imposed here.

The second electrode layer (1-4) includes an insulating layer (1-45), a first electrode structure (1-41), and a second electrode structure (1-42). One of the electrode structures (1-41 or 1-42) is located on the side of the insulating layer (1-45) facing the liquid crystal layer (1-3), while the other is located on the side of the insulating layer (1-45) opposite the liquid crystal layer (1-3).

In this embodiment, the second electrode layer (1-4) adopts a configuration with two vertically arranged electrode structures, separated by the insulating layer (1-45). Specifically, the first electrode structure (1-41) can be positioned on the side of the insulating layer (1-45) facing the liquid crystal layer (1-3), and the second electrode structure (1-42) can be positioned on the side of the insulating layer (1-45) opposite the liquid crystal layer (1-3). Alternatively, the second electrode structure (1-42) can be positioned on the side of the insulating layer (1-45) facing the liquid crystal layer (1-3), and the first electrode structure (1-41) can be positioned on the side of the insulating layer (1-45) opposite the liquid crystal layer (1-3). No limitations are imposed on these configurations.

The first electrode structure (1-41) is provided with a first driving voltage loading position and a second driving voltage loading position. The first driving voltage loading position is used to receive the first driving voltage, while the second driving voltage loading position is used to receive the second driving voltage. The first driving voltage differs from the second driving voltage.

When the first driving voltage is applied to the first driving voltage loading position of the first electrode structure (1-41), and the second driving voltage is applied to the second driving voltage loading position of the second electrode structure (1-42), a gradient-distributed potential can be formed on the first electrode structure (1-41). This allows the spatial potential distribution to be controlled by adjusting the position of the first electrode structure (1-41) in space.

The second electrode structure (1-42) is provided with a third driving voltage loading position and a fourth driving voltage loading position. The third driving voltage loading position is used to receive the third driving voltage, while the fourth driving voltage loading position is used to receive the fourth driving voltage. The third driving voltage differs from the fourth driving voltage.

When the third driving voltage is applied to the third driving voltage loading position of the second electrode structure (1-42), and the fourth driving voltage is applied to the fourth driving voltage loading position of the second electrode structure (1-42), a gradient-distributed potential can also be formed on the second electrode structure (1-42). This allows the spatial potential distribution to be controlled by adjusting the position of the second electrode structure (1-42) in space.

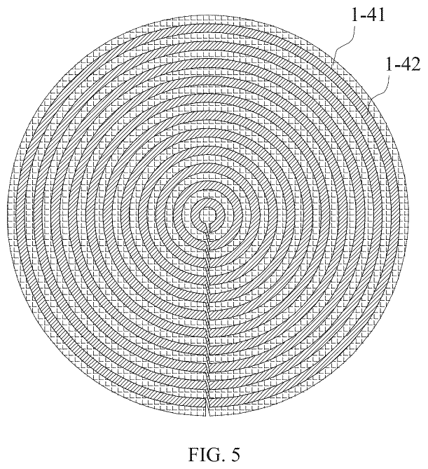

The first electrode structure (1-41) includes at least two segments, and there are gaps (1-44) between at least some adjacent segments of the first electrode structure (1-41). The second electrode structure (1-42) also includes at least two segments, and there are gaps (1-44) between at least some adjacent segments of the second electrode structure (1-42). As shown in FIGS. 5, 8, and 11, the projection of the second electrode structure (1-42) on the plane where the first electrode structure (1-41) is located fully or partially covers the gap (1-44) between adjacent segments of the first electrode structure (1-41), and the projection of the first electrode structure (1-41) on the plane where the second electrode structure (1-42) is located fully or partially covers the gap (1-44) between adjacent segments of the second electrode structure (1-42).

“Full coverage” means that the projection of one electrode structure completely covers the gap (1-44). In this case, the area occupied by the projection of the electrode structure can be larger than or exactly equal to the gap (1-44). “Partial coverage” means that the projection of one electrode structure only covers part of the gap (1-44).

Adjacent segments refer to different parts of the same electrode structure that are spatially next to each other. To generate a gradient-distributed potential, the potential in some areas of the first electrode structure (1-41) typically differs between different parts, so gaps (1-44) are left between adjacent segments in these areas to prevent interference. Similarly, there are gaps (1-44) between at least part of adjacent segments in the second electrode structure (1-42).

Although applying a driving voltage to either the first electrode structure (1-41) or the second electrode structure (1-42) alone can produce a relatively precise spatial potential distribution, it can also cause diffraction. To address this, in this embodiment, one electrode structure covers the gap (1-44) of the other electrode structure, and both electrode structures are driven simultaneously. This eliminates the diffraction phenomenon in the liquid crystal optical device.

The liquid crystal optical device in this embodiment includes, but is not limited to, liquid crystal lenses and liquid crystal Fresnel lenses.

The third driving voltage and the first driving voltage can be the same or different. When the third driving voltage is different from the first driving voltage, the third driving voltage can be greater than or less than the first driving voltage. Similarly, the fourth driving voltage and the second driving voltage can be the same or different. When the fourth driving voltage is different from the second driving voltage, the fourth driving voltage can be greater than or less than the second driving voltage. For example, the first driving voltage can be set to 1.6 Vrms, the second driving voltage can be set to 2.5 Vrms, the third driving voltage can be set to 1.65 Vrms, and the fourth driving voltage can be set to 2.55 Vrms.

As an optional but advantageous embodiment, in this example, the projection of the first electrode structure (1-41) coincides with the gaps (1-44) between adjacent segments of the second electrode structure (1-42). By adopting this structure, not only can diffraction phenomena be eliminated, but the capacitance effect between the upper and lower electrode structures can also be effectively reduced. As another optional but advantageous embodiment, in this example, the first electrode structure (1-41) includes a first electrode wire (1-411) extending from one end near the central position of the second electrode layer (1-4) toward the other end near the edge position of the second electrode layer (1-4). One end of the first electrode wire (1-411) is used to receive the first driving voltage, while the opposite end is used to receive the second driving voltage. In this example, the first electrode wire (1-411) extends radially outward, allowing it to cover all radial positions of the second electrode layer (1-4). This arrangement enables the functional area of the liquid crystal optical device to exhibit a gradient potential distribution, and the liquid crystal material in the liquid crystal layer (1-3) can deflect under the influence of the electric field to form a liquid crystal lens based on the shape of the first electrode wire (1-411).

The second electrode structure (1-42) includes a second electrode wire (1-421) extending from one end near the central position of the second electrode layer (1-4) toward the other end near the edge position of the second electrode layer (1-4). One end of the second electrode wire (1-421) is used to receive the third driving voltage, while the opposite end is used to receive the fourth driving voltage. The second electrode structure (1-42) may adopt a shape similar to that of the first electrode structure (1-41). This design not only effectively covers the gaps (1-44) between adjacent segments of the first electrode structure (1-41) but also maintains consistency with the potential distribution generated by the first electrode structure (1-41).

As shown in FIG. 3, as one optional but advantageous embodiment, in this example, the first electrode wire (1-411) includes several concentric arc segments (1-431) with different radii. Each concentric arc segment (1-431) in the first electrode wire (1-411) serves as a segment of the first electrode structure (1-41). Gaps (1-44) are arranged between adjacent concentric arc segments in the first electrode wire (1-411), and adjacent concentric arc segments in the first electrode wire are connected by transition segments (1-432).

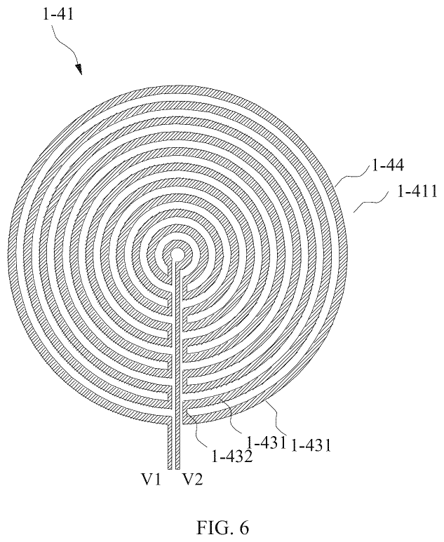

As shown in FIGS. 3 and 6, the second electrode wire (1-421) also includes several concentric arc segments (1-431) with different radii. Gaps (1-44) are arranged between adjacent concentric arc segments in the second electrode wire, and each concentric arc segment (1-431) in the second electrode wire (1-421) serves as a segment of the second electrode structure (1-42). Adjacent concentric arc segments in the second electrode wire are connected by transition segments (1-432). The projections of the arc segments in the first electrode structure (1-41) on the plane where the second electrode structure (1-42) is located completely or partially cover the gaps (1-44) between adjacent concentric arc segments in the second electrode structure (1-42).

This embodiment utilizes concentric arc segments (1-431) with different radii to control the potential distribution at different radii of the liquid crystal lens. These concentric arc segments (1-431) are connected by transition segments (1-432). When the two driving voltage loading positions of the first electrode wire (1-411) are loaded with the first driving voltage and the second driving voltage, respectively, a precise parabolic potential distribution can be formed, thereby achieving a high-precision liquid crystal lens.

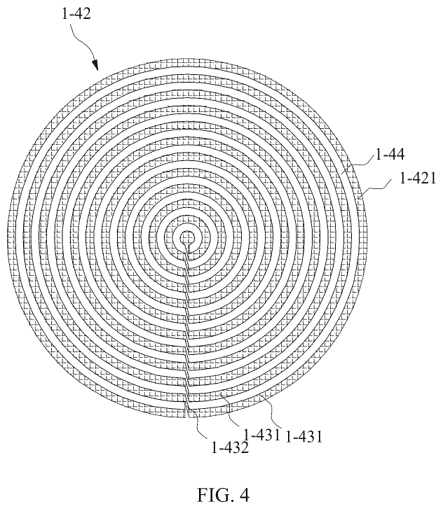

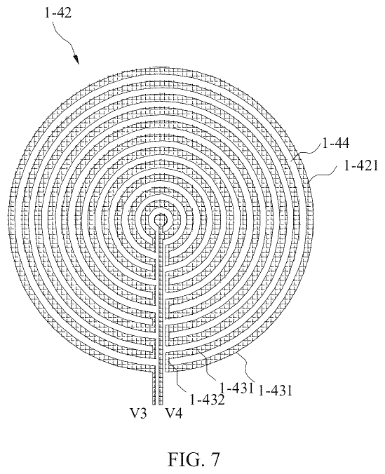

As shown in FIGS. 4 and 7, the concentric arc segments (1-431) of the second electrode wire (1-421) cover the gaps (1-44) between adjacent concentric arc segments (1-431) of the first electrode wire (1-411), effectively eliminating the diffraction phenomenon caused by the gaps (1-44) between the concentric arc segments (1-431).

In specific implementations, the electrode wire structures of concentric arc segments (1-431) shown in FIGS. 3 and 4 can be used, or the electrode wire structures of concentric arc segments (1-431) shown in FIGS. 6 and 7 can be adopted. In FIGS. 6 and 7, the electrode leads for loading driving voltages to the first electrode wire (1-411) and the second electrode wire (1-421) are introduced to the central position of the second electrode layer (1-4). The transition segments (1-432) connecting adjacent concentric arc segments (1-431) are positioned on one side of the electrode leads and do not cross the electrode leads.

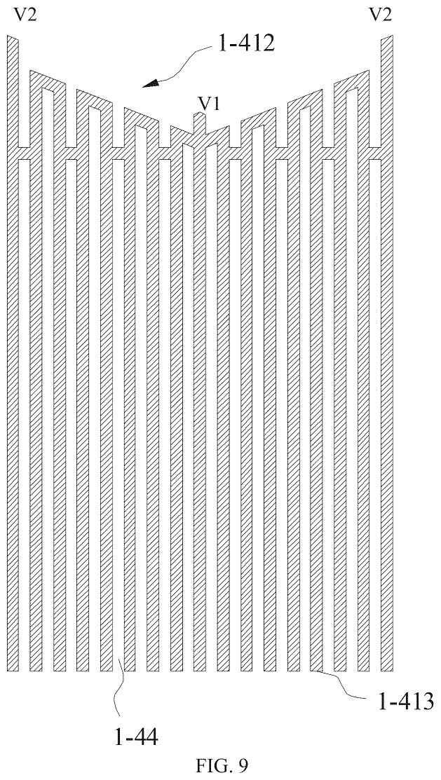

As shown in FIG. 9, as an optional but advantageous embodiment, in this example, the first electrode structure (1-41) includes a first potential distribution wire (1-412) and several third electrode wires (1-413). Each third electrode wire serves as a segment of the first electrode structure. The first driving voltage loading position and the second driving voltage loading position are set on the first potential distribution wire (1-412). One end of each third electrode wire (1-413) is connected to the first potential distribution wire (1-412), while the opposite end is suspended. When the first driving voltage and the second driving voltage are applied at the first driving voltage loading position and the second driving voltage loading position of the first potential distribution wire (1-412), respectively, and a voltage difference is maintained between them, the potential between the two driving voltage loading positions on the first potential distribution wire (1-412) forms a gradient distribution. Different positions on the first potential distribution wire (1-412) exhibit different potentials.

The third electrode wires (1-413) are straight and parallel to the first direction. The connection points of the third electrode wires (1-413) to the first potential distribution wire (1-412) are located between the first driving voltage loading position and the second driving voltage loading position. Different third electrode wires (1-413) are connected to different positions on the first potential distribution wire (1-412).

Since the first potential distribution wire (1-412) has a certain resistance, there is a voltage drop along the line. Due to the varying resistance between the connection points of each third electrode wire (1-413) and the first driving voltage loading position on the first potential distribution wire (1-412), the potential at each connection point also differs. By controlling the connection positions of the third electrode wires (1-413) on the first potential distribution wire (1-412) and the positions traversed by the third electrode wires (1-413), the potential distribution of the liquid crystal optical device can be controlled.

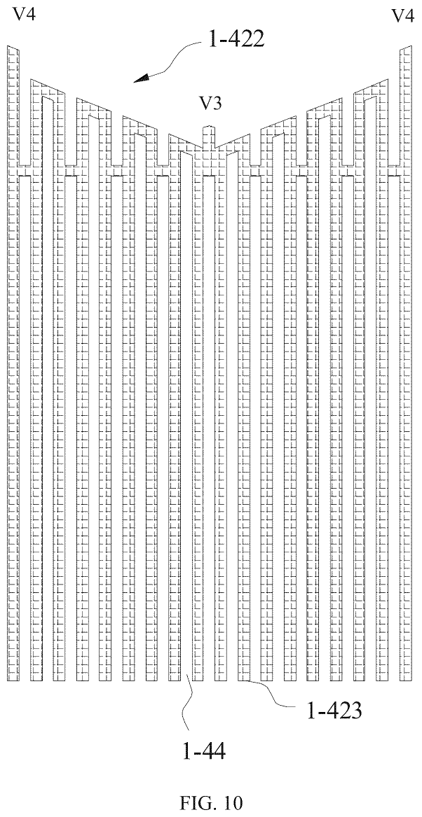

As shown in FIG. 10, the second electrode structure (1-42) includes a second potential distribution wire (1-422) and several fourth electrode wires (1-423). The fourth electrode wires (1-423) are straight, with each fourth electrode wire serving as a segment of the second electrode structure. All the fourth electrode wires (1-423) are parallel to the first direction. The third driving voltage loading position and the fourth driving voltage loading position are set on the second potential distribution wire (1-422). One end of each fourth electrode wire (1-423) is connected to the second potential distribution wire (1-422), while the opposite end is suspended.

The connection points of the fourth electrode wires (1-423) to the second potential distribution wire (1-422) are located between the third driving voltage loading position and the fourth driving voltage loading position. Different fourth electrode wires (1-423) are connected to different positions on the second potential distribution wire (1-422).

When the third driving voltage and the fourth driving voltage are applied at the third driving voltage loading position and the fourth driving voltage loading position of the second potential distribution wire (1-422), respectively, and a voltage difference is maintained between them, the potential between the two driving voltage loading positions on the second potential distribution wire (1-422) forms a gradient distribution. Different positions on the second potential distribution wire (1-422) exhibit different potentials.

Since the second potential distribution wire (1-422) has a certain resistance, there is a voltage drop along the line. Due to the varying resistance between the connection points of each fourth electrode wire (1-423) and the third driving voltage loading position on the second potential distribution wire (1-422), the potential at each connection point also differs. By controlling the connection positions of the fourth electrode wires (1-423) on the second potential distribution wire (1-422) and the positions traversed by the third electrode wires (1-413), the potential distribution of the liquid crystal optical device can be precisely controlled.

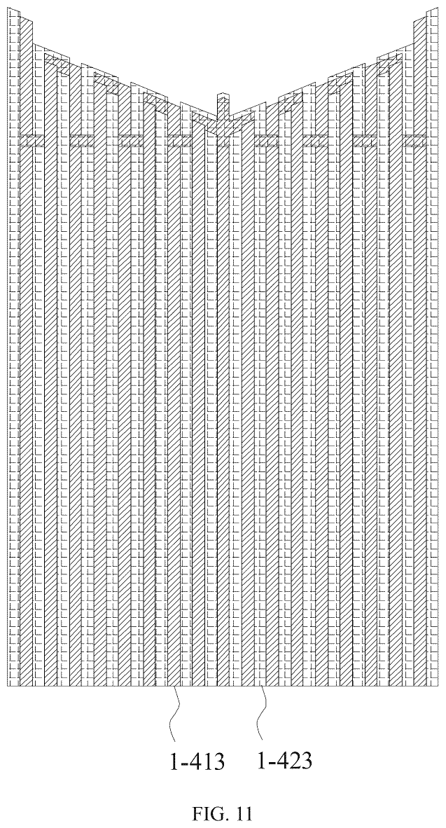

As shown in FIG. 11, the projection of the fourth electrode wires (1-423) onto the plane of the third electrode wires (1-413) covers the gaps (1-44) between adjacent third electrode wires (1-413). Similarly, the projection of the third electrode wires (1-413) onto the plane of the fourth electrode wires (1-423) covers the gaps (1-44) between adjacent fourth electrode wires (1-423). Specifically, the projection of the third electrode wires (1-413) covers the gaps (1-44) between adjacent fourth electrode wires (1-423), and the projection of the fourth electrode wires (1-423) also covers the gaps (1-44) between adjacent third electrode wires (1-413).

As an optional but advantageous embodiment, in this implementation, the resistance between the connection points of the first potential distribution wire (1-412) and each third electrode wire (1-413) to the first driving voltage loading position is parabolically related to the distance in the second direction between these connection points and the first driving voltage loading position. Specifically, let the resistance between the connection points of the first potential distribution wire (1-412) and each third electrode wire (1-413) to the first driving voltage loading position be the first coordinate y, and the corresponding distance between the connection points and the first driving voltage loading position in the second direction be the second coordinate x. The curve formed in a Cartesian coordinate system defined by x and y is a parabola, expressed as y=kx², where k is a nonzero real number.

Similarly, the resistance between the connection points of the second potential distribution wire (1-422) and each fourth electrode wire (1-423) to the third driving voltage loading position is parabolically related to the distance in the second direction between these connection points and the third driving voltage loading position. Let the resistance between the connection points of the second potential distribution wire (1-422) and each fourth electrode wire (1-423) to the third driving voltage loading position be the first coordinate y, and the corresponding distance between the connection points and the third driving voltage loading position in the second direction be the second coordinate x. The curve formed in a Cartesian coordinate system defined by x and y is a parabola, expressed as y=kx². where k is a nonzero real number.

The second direction is perpendicular to the first direction. Because the resistance between the connection points of the first potential distribution wire (1-412) and each third electrode wire (1-413) to the first driving voltage loading position is parabolically related to the distance in the second direction, the third electrode wires (1-413) can form a parabolic cylindrical potential distribution in the surrounding space. Similarly, because the resistance between the connection points of the second potential distribution wire (1-422) and each fourth electrode wire (1-423) to the third driving voltage loading position is parabolically related to the distance in the second direction, the fourth electrode wires (1-423) can form a parabolic cylindrical potential distribution in the surrounding space.

When the projections of the first electrode structure (1-41) and the second electrode structure (1-42) overlap, not only can a high-precision cylindrical lens be formed, but diffraction phenomena can also be effectively eliminated.

As an optional but advantageous embodiment, in this implementation, the first potential distribution wire (1-412) and the second potential distribution wire (1-422) are uniformly wide potential distribution wires. The length between the connection points of the first potential distribution wire (1-412) and each third electrode wire (1-413) to the first driving voltage loading position is parabolically related to the distance in the second direction between these connection points and the first driving voltage loading position. Similarly, the length between the connection points of the second potential distribution wire (1-422) and each fourth electrode wire (1-423) to the third driving voltage loading position is parabolically related to the distance in the second direction between these connection points and the third driving voltage loading position.

In this embodiment, the first potential distribution wire (1-412) and the second potential distribution wire (1-422) are uniformly wide, ensuring that the resistance of each segment of these lines is proportional to its length. By controlling the length of the first potential distribution wire (1-412) at the connection points of the third electrode wires (1-413) and the length of the second potential distribution wire (1-422) at the connection points of the fourth electrode wires (1-423), the potential controlled by the first electrode structure (1-41) and the second electrode structure (1-42) can achieve an accurate parabolic cylindrical distribution.

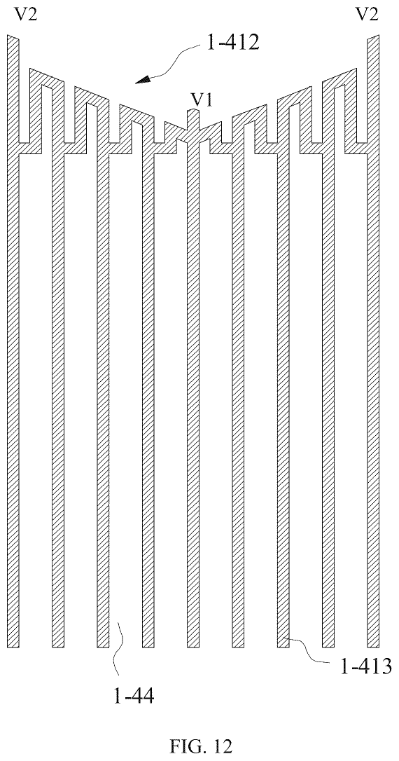

In this implementation, the width of the third electrode wires (1-413) may be greater than, equal to, or less than the width of the fourth electrode wires (1-423). As shown in FIGS. 12 to 14, the width of the third electrode wires (1-413) can also be smaller than that of the fourth electrode wires (1-423).

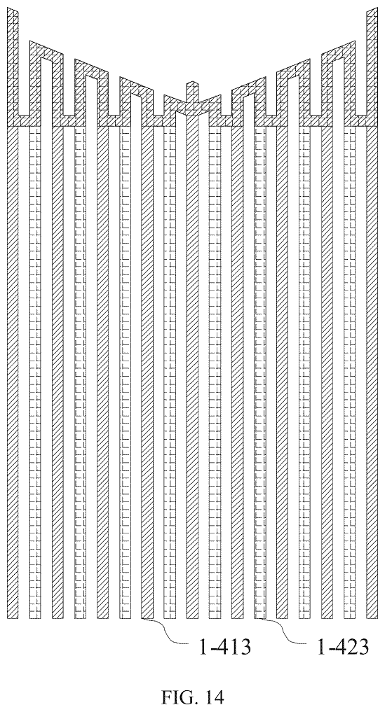

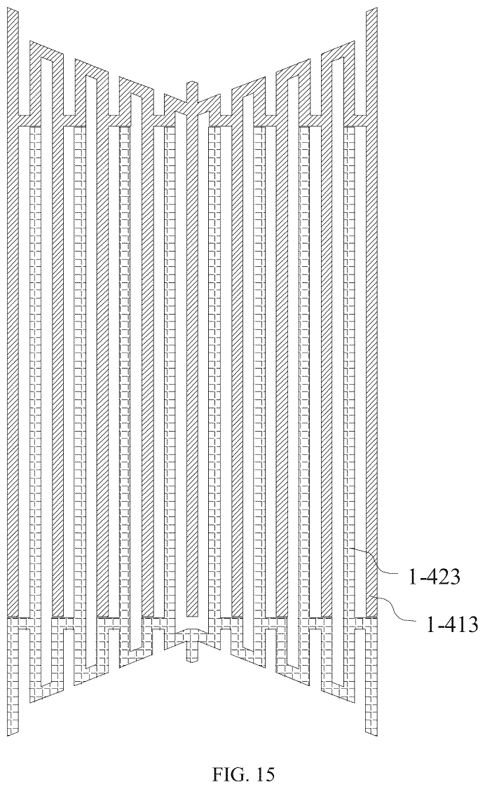

The first potential distribution wire (1-412) and the second potential distribution wire (1-422) can be located on the same side (see FIG. 14) or on opposite sides (see FIG. 15), without limitation in this regard.

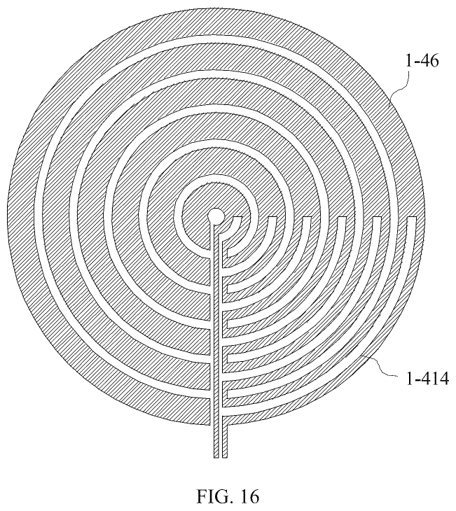

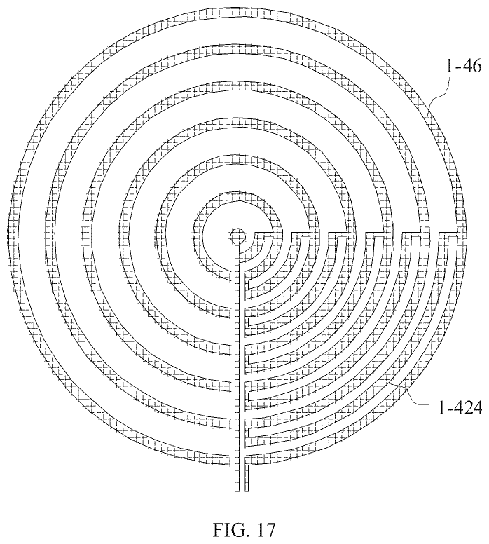

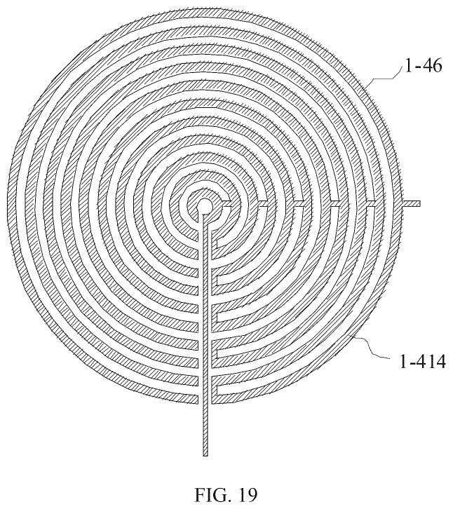

As illustrated in FIGS. 16 and 19, in this example, the first electrode structure includes a third potential distribution wire (1-414) and several concentric arc electrode wires (1-46). Each concentric arc electrode wire (1-46) serves as a segment of the first electrode structure. The third potential distribution wire (1-414) extends from the center of the liquid crystal lens to its edge, with its opposite ends serving as the first and second driving voltage loading positions.

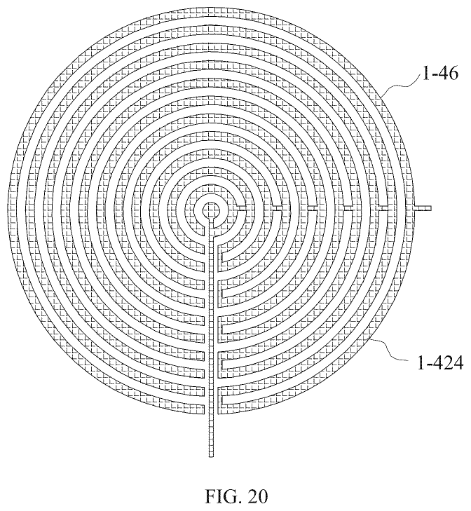

As shown in FIGS. 17 and 20, the second electrode structure includes a fourth potential distribution wire (1-424) and several concentric arc electrode wires (1-46). Each concentric arc electrode wire (1-46) in the second electrode structure serves as a segment of the second electrode. The fourth potential distribution wire (1-424) extends from the center of the liquid crystal lens to its edge, with its opposite ends serving as the third and fourth driving voltage loading positions.

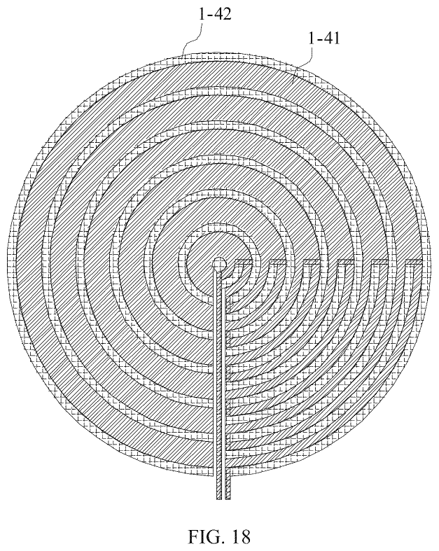

FIGS. 18, 21, and 22 demonstrate that the projection of the concentric arc electrode wires (1-46) in the first electrode structure on the plane of the second electrode structure covers the gaps between adjacent concentric arc electrode wires (1-46) in the second electrode structure.

To form a parabolic potential distribution, one end of each concentric arc electrode wire (1-46) in this example is connected to the potential distribution wire, while the other end remains suspended. The connection points between the first potential distribution wire and the concentric arc electrode wires serve as potential extraction points. The resistance between each potential extraction point and the first driving voltage loading position, as well as the radial distance of each extraction point from the first driving voltage loading position, follow a parabolic distribution.

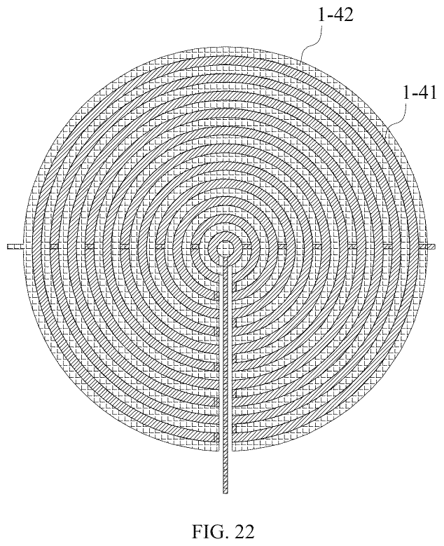

To achieve a large-aperture liquid crystal lens and reduce the voltage difference between driving voltages, as illustrated in FIGS. 22 through 26, the liquid crystal optical device in this example can be configured as a liquid crystal Fresnel lens. As an optional but advantageous embodiment, as shown in FIG. 22, the first electrode structure (1-41) consists of several first electrode units arranged sequentially from the center to the edge of the second electrode layer (1-4). Under the drive of the first and second driving voltages, the surface electrode and the individual electrode units cause the molecules of liquid crystals in the liquid crystal layer (1-3) to rotate, forming a liquid crystal Fresnel lens.

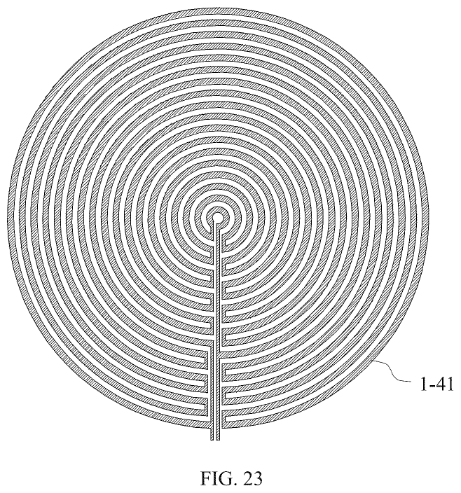

As shown in FIG. 23, the second electrode structure (1-42) includes several first electrode units arranged sequentially from the center to the edge of the second electrode layer (1-4). Under the drive of the third and fourth driving voltages, the surface electrode and each first electrode unit cause the molecules of liquid crystal in the liquid crystal layer (1-3) to rotate, forming a liquid crystal Fresnel lens. Each first electrode unit controls the deflection of the liquid crystal material in a ring zone, such that the phase delay effect of the deflected light passing through matches that of a Fresnel lens ring. With the coordinated action of all the first electrode units, the deflection of the liquid crystal material results in the formation of a liquid crystal Fresnel lens.

As an optional but advantageous embodiment, in this example, the first electrode structure (1-41) includes multiple second electrode units arranged along the first direction. Under the drive of the first and second driving voltages, the surface electrode and each of these electrode units cause the liquid crystal in the liquid crystal layer (1-3) to deflect, forming a liquid crystal Fresnel cylindrical lens. Similarly, the second electrode structure (1-42) includes multiple second electrode units arranged along the first direction. Under the drive of the third and fourth driving voltages, the surface electrode and each of these second electrode units cause the liquid crystal in the liquid crystal layer (1-3) to deflect, forming a liquid crystal Fresnel cylindrical lens.

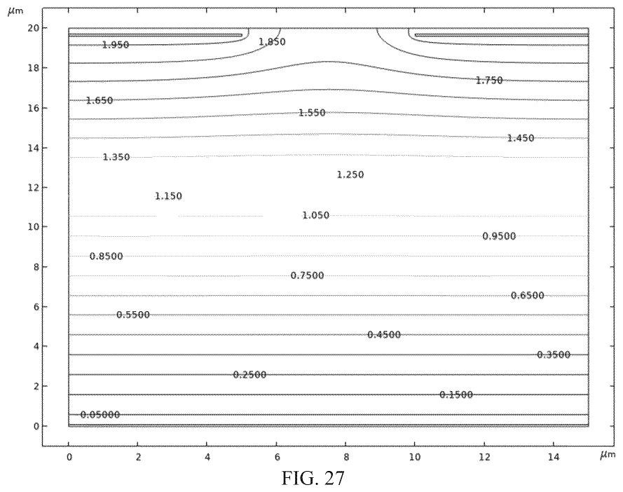

The liquid crystal Fresnel cylindrical lens formed by this structure not only achieves high precision in potential distribution but also effectively eliminates diffraction phenomena. The potential distribution effects of the liquid crystal lens in this example can be observed in FIGS. 27, 28, and 29.

### Embodiment 2

As shown in FIG. 30, this embodiment provides a liquid crystal optical device that primarily consists of a sequentially stacked structure, including a first substrate (2-1), a first electrode layer (2-2), a liquid crystal layer (2-3), a second electrode layer (2-4), and a second substrate (2-5).

The form of the first electrode layer (2-2) can be configured as needed. For instance, it can be set as a planar electrode, allowing the first electrode layer (2-2) to form an equipotential plane, or it can be configured in various patterned electrode forms. These configurations are not limited in this description.

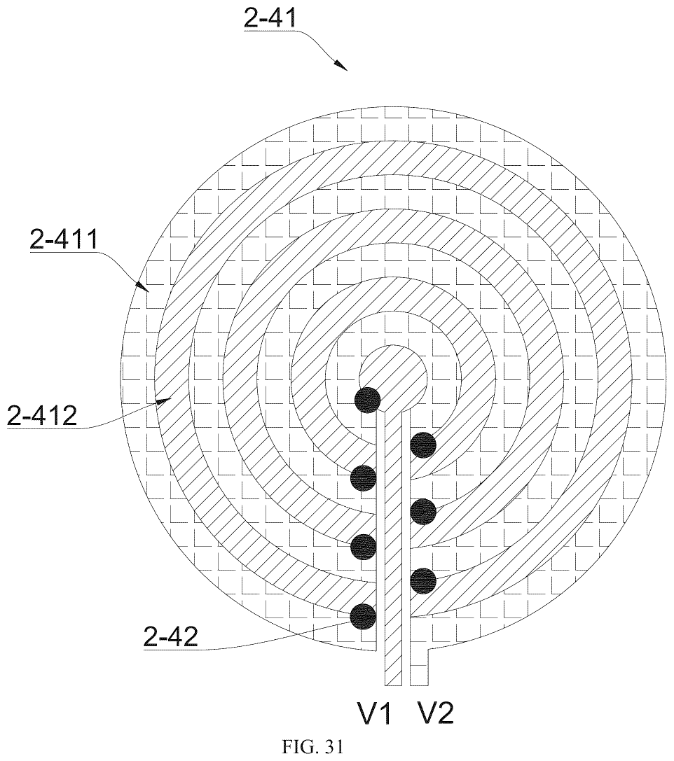

As shown in FIG. 31, the second electrode layer (2-4) includes a first insulation layer (2-42) and electrode units (2-41). As illustrated in FIG. 30, each electrode unit (2-41) consists of a first electrode structure (2-411) and a second electrode structure (2-412), which are located on opposite sides of the first insulation layer (2-42).

Each electrode unit (2-41) has a first driving voltage loading position and a second driving voltage loading position. The first driving voltage loading position is used to receive the first driving voltage V1, and the second driving voltage loading position is used to receive the second driving voltage V2. The first and second driving voltages are not identical, and the voltage difference drives the deflection of liquid crystal molecules.

For example, when using positive liquid crystal materials arranged in a planar orientation:

If V1=1.6 Vrms, and V2=2.0 Vrms, a positive lens effect can be achieved.

If V1=2.0 Vrms and V2=1.6 Vrms, a negative lens effect can be achieved.

In this embodiment, the electrode unit (2-41) is distributed in two different planes. Specifically, a portion of the electrode unit (2-41) is located on one side of the first insulating layer (2-42), which is farther from the liquid crystal layer, and another portion is located on the side of the first insulating layer (2-42) closer to the liquid crystal layer. For convenience, we will refer to the portion of the electrode unit (2-41) on the same side of the first insulating layer (2-42) as a subsection, which includes the first electrode structure (2-411) and the second electrode structure (2-412). The first electrode structure (2-411) can be set on the side of the first insulating layer (2-42) that is farther from the liquid crystal layer, while the second electrode structure (2-412) can be set on the side closer to the liquid crystal layer. Alternatively, the second electrode structure (2-412) can be placed on the side of the first insulating layer (2-42) farther from the liquid crystal layer, with the first electrode structure (2-411) on the side closer to the liquid crystal layer. The configuration is not limited by this description.

Although the electrode unit (2-41) in this embodiment includes the first electrode structure (2-411) and the second electrode structure (2-412) distributed on opposite sides of the first insulating layer (2-42), both structures are part of the same electrode unit (2- 41) and are electrically connected. Under the drive of the first and second driving voltages, they generate a gradient electric potential distribution. By controlling the spatial positions of the electrode unit (2-41), the spatial potential distribution can be controlled.

The first electrode structure (2-411) includes at least two first segments, with at least some adjacent first segments having gaps (2-47) between them. The second electrode structure (2-412) includes at least two second segments, with at least some adjacent second segments also having gaps (2-47) between them. The projection of the second electrode structure (2-412) on the first reference plane at least partially covers the gap (2-47) between adjacent first segments of the first electrode structure (2-411). Similarly, the projection of the first electrode structure (2-411) on the first reference plane at least partially covers the gap (2-47) between adjacent second segments of the second electrode structure (2-412). The first reference plane refers to the top or bottom surface of the first electrode structure (2-411), and the second reference plane refers to the top or bottom surface of the second electrode structure (2-412).

In certain areas of the first electrode structure (2-411), a potential difference is required between different parts. To prevent mutual interference, gaps (2-47) are left between adjacent first segments in these areas. Similarly, in some areas of the second electrode structure (2-412), a potential difference is required, so gaps (2-47) are also left between adjacent second segments to prevent mutual interference.

The projection of one segment may partially or fully cover the gap (2-47) of another segment. Full coverage means that the projection of one segment completely covers the gap (2-47) of another segment. In this case, the area occupied by the projection can be larger than or exactly equal to the gap (2-47). Partial coverage means that the projection of one segment only covers part of the gap (2-47).

In this embodiment, the first insulating layer (2-42) is provided with a through hole (2-43), which pass through the insulating layer. The through hole contain connecting parts that electrically connect adjacent first and second segments. The electrode unit (2-41) is arranged such that its segments alternate between the side of the first insulating layer (2-42) closer to the liquid crystal layer and the side farther from the liquid crystal layer. For example, the first segment (the previous segment) of the electrode unit (2-41) is positioned on the side of the first insulating layer (2-42) closer to the liquid crystal layer, while the next segment (the second segment) is positioned on the side farther from the liquid crystal layer. These two segments are electrically connected through the connecting part in the through-hole (2-43).

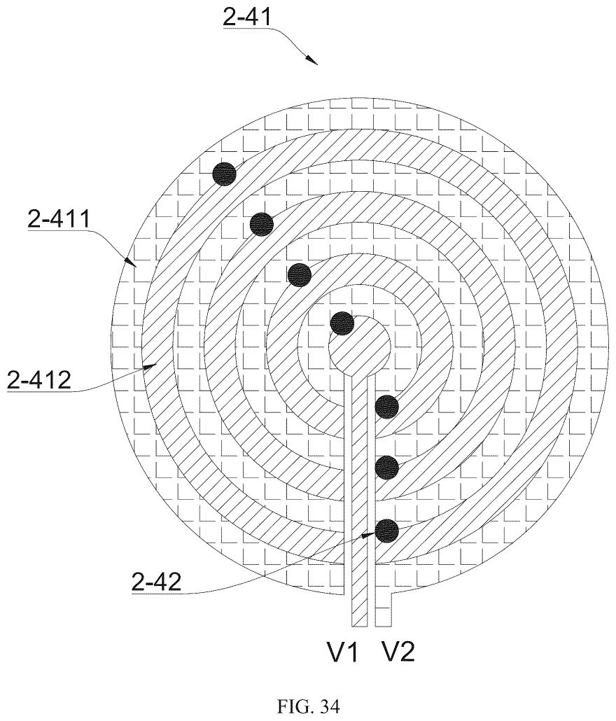

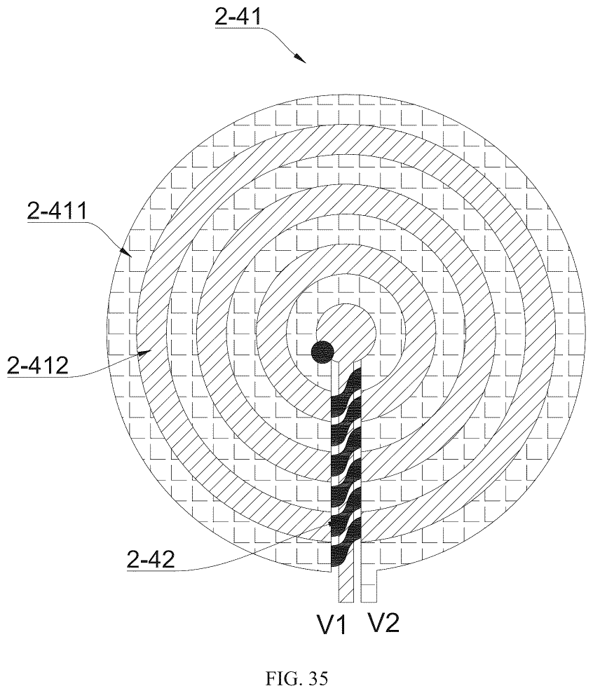

Alternatively, the second segment (the previous segment) of the electrode unit (2-41) can be placed on the side of the first insulating layer (2-42) farther from the liquid crystal layer, while the next segment (the first segment) is positioned on the side closer to the liquid crystal layer. Again, these segments are electrically connected through the connecting part in the through-hole (2-43). The position and shape of the through-hole (2-43) can be configured as needed, and FIGS. 34 and 35 show two other possible configurations for the through holes.

This embodiment arranges the electrode unit (2-41) on both sides of the first insulating layer (2-42), ensuring that there is sufficient gap (2-47) between adjacent parts of the electrode unit (2-41) within the same layer. Additionally, the projection of the segment on the side of the first insulating layer (2-42) covers the gap (2-47) between adjacent segments on the other side. This configuration effectively eliminates diffraction effects caused by the gaps between adjacent subsections, significantly improving the optical performance of the liquid crystal optical device.

As an optional but beneficial embodiment, in this implementation, the projection of the first electrode structure (2-411) on the second reference plane coincides with the gap (2-47) between adjacent subsections of the second electrode structure (2-412).

After adopting the aforementioned structure, the projection of the first electrode structure (2-411) completely coincides with the gap (2-47) between adjacent concentric arc segments (2-44) of the second electrode structure (2-412). This structure not only eliminates diffraction effects but also effectively reduces the capacitive coupling between the upper and lower electrode parts.

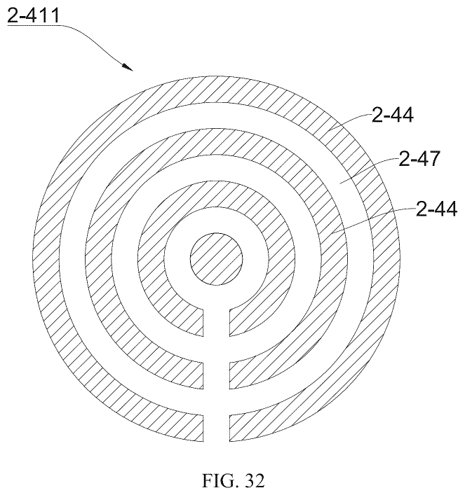

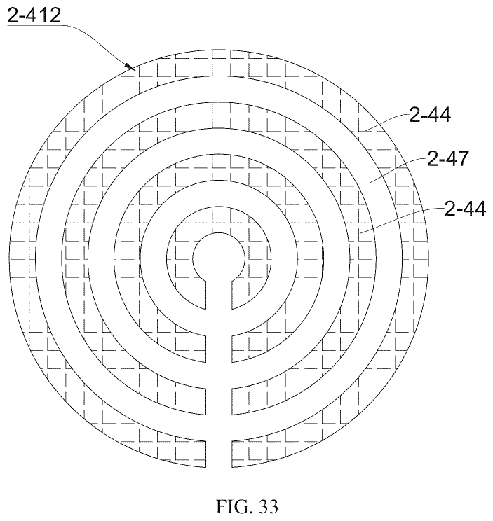

As shown in FIGS. 32 and 33, in this embodiment, the first electrode structure (2-411) includes several concentric arc segments (2-44) with different radii. Each concentric arc segment (2-44) serves as a first segment of the first electrode structure. A gap (2-47) is set between adjacent concentric arc segments (2-44) within the first electrode structure (2-411), and the number of concentric arc segments (2-44) in the first electrode structure is greater than or equal to two.

Similarly, the second electrode structure (2-412) also includes several concentric arc segments (2-44) with different radii, with each concentric arc segment (2-44) serving as a second segment of the second electrode structure. Gaps (2-47) are set between adjacent concentric arc segments (2-44) within the second electrode structure (2-412), and the number of concentric arc segments (2-44) in the second electrode structure is also greater than or equal to two.

The first electrode structure (2-411) and the second electrode structure (2-412) are electrically connected through the connecting part in the through hole (2-43) between adjacent concentric arc segments (2-44). The use of concentric arc segments (2-44) with different radii in the electrode unit (2-41) controls the potential distribution at different radii of the liquid crystal lens. The adjacent concentric arc segments (2-44) are positioned on opposite sides of the first insulating layer (2-42) and are electrically connected through the connecting part in the through-hole (2-43). This allows the potential to decrease or increase in concentric circles from the center outward, and the overall electrode unit (2-41), under the influence of the first and second driving voltages, can create a rotational parabolic potential distribution in space.

Additionally, the projection of the concentric arc segments (2-44) of the first electrode structure (2-411) in the plane of the second electrode structure (2-412) at least partially overlaps with the gap (2-47) between adjacent concentric arc segments (2-44) of the second electrode structure. This projection, in the second reference plane, also partially covers the gap (2-47) between adjacent concentric arc segments (2-44) of the second electrode structure (2-412). This configuration effectively eliminates the diffraction effects caused by the gaps between concentric arc segments (2-44) in the same layer.

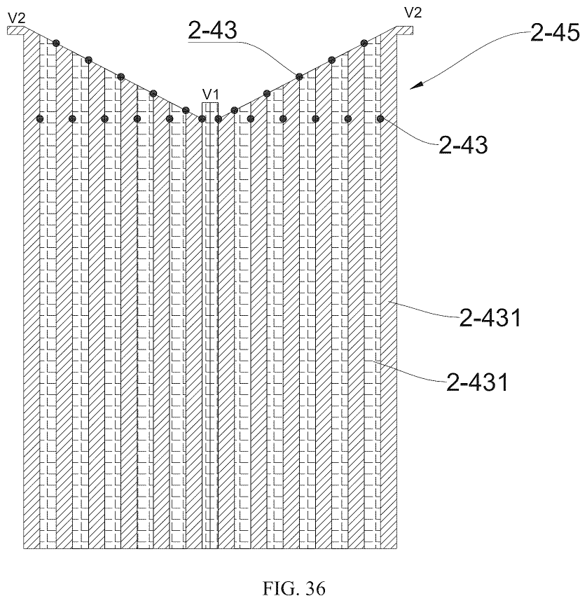

As shown in FIGS. 36, 37, and 38, this embodiment can also achieve a liquid crystal cylindrical lens. In this configuration, the electrode unit (2-41) includes a potential distribution wire (2-45) and at least two electrode wires (2-431). A portion of the potential distribution wire (2-45) belongs to the first electrode structure (2-411), while the other portion belongs to the second electrode structure (2-412). Similarly, part of the electrode wires (2-431) belongs to the first electrode structure (2-411), and the remaining portion belongs to the second electrode structure (2-412).

Each electrode wire (2-431) in the first electrode structure (2-411) serves as a first segment, while each electrode wire (2-431) in the second electrode structure (2-412) serves as a second segment. The electrode wires (2-431) are straight and aligned parallel to a first direction. The first driving voltage loading position and the second driving voltage loading position are arranged on the potential distribution wire (2-45). One end of each electrode wire (2-431) is connected to the potential distribution wire (2-45), while the opposite end is suspended.

When a first driving voltage and a second driving voltage are applied to the first and second driving voltage loading positions of the potential distribution wire (2-45), respectively, and a voltage difference exists between them, the potential along the potential distribution wire (2-45) between the two driving voltage loading positions exhibits a gradient distribution. As a result, different positions on the potential distribution wire (2-45) have different potentials.

In this embodiment, the positions where the electrode wires (2-431) connect to the potential distribution wire (2-45) are located between the first and second driving voltage loading positions. Each electrode wire (2-431) connects to a unique position on the potential distribution wire (2-45). Due to the inherent resistance of the potential distribution wire (2-45), there is a voltage drop along its length. Consequently, the potential at the connection points between each electrode wire (2-431) and the potential distribution wire (2-45) differs based on the resistance between the connection point and the first driving voltage loading position. By controlling the connection positions of the electrode wires (2-431) on the potential distribution wire (2-45) and their spatial arrangement, the potential distribution of the liquid crystal optical device can be regulated.

The projection of the electrode wires (2-431) belonging to the first electrode structure (2-411) on the second reference plane covers the gaps (2-47) between adjacent electrode wires (2-431) in the second electrode structure (2-412). Similarly, the projection of the electrode wires (2-431) belonging to the second electrode structure (2-412) on the first reference plane covers the gaps (2-47) between adjacent electrode wires (2-431) in the first electrode structure (2-411). By using the projections of electrode wires (2-431) from the two separate sections to cover the gaps (2-47) between electrode wires (2-431), this embodiment effectively eliminates the capacitive effects generated in the electrode unit (2-41) when driving voltages are applied. Additionally, adjacent electrode wires (2-431) on both sides can be electrically connected through connecting parts arranged in through-holes.

As one example, in this embodiment, the resistance between the connection points of each electrode wire (2-431) on the potential distribution wire (2-45) and the first driving voltage loading position, and the distance between these connection points and the first driving voltage loading position in the second direction, exhibit either a parabolic or linear relationship. The second direction is perpendicular to the first direction.

As shown in FIG. 36, when the resistance between the connection points of each electrode wire (2-431) on the potential distribution wire (2-45) and the first driving voltage loading position, and the distance between these connection points and the first driving voltage loading position in the second direction, exhibit a parabolic relationship, the resistance value between the connection points and the first driving voltage loading position is taken as the first coordinate (y), while the distance between the connection points and the first driving voltage loading position in the second direction is taken as the second coordinate (x). In the Cartesian coordinate system formed by the first and second coordinates, the resulting function graph is a parabola, satisfying y=kx² where k is a non-zero real number.

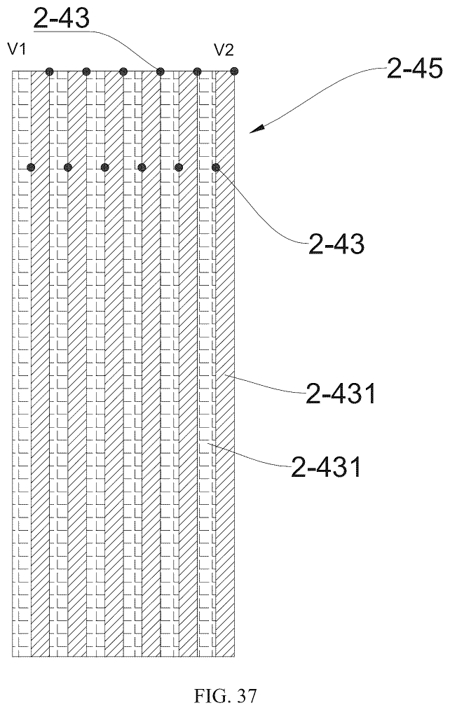

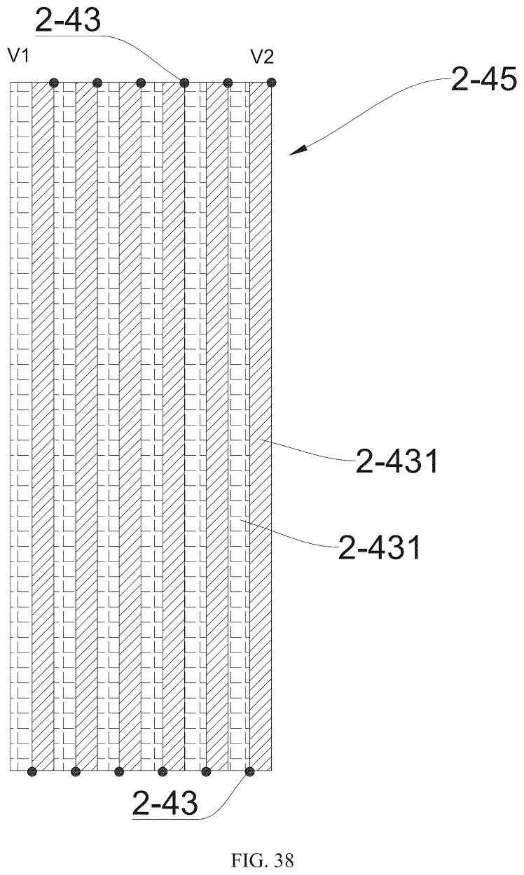

As shown in FIGS. 37 and 38, when the resistance between the connection points of each electrode wire (2-431) on the potential distribution wire (2-45) and the first driving voltage loading position, and the distance between these connection points and the first driving voltage loading position in the second direction, exhibit a linear relationship, the resistance value between the connection points and the first driving voltage loading position is taken as the first coordinate (y), while the distance between the connection points and the first driving voltage loading position in the second direction is taken as the second coordinate (x). In the Cartesian coordinate system formed by the first and second coordinates, the resulting function graph is a straight line, satisfying y=ax+b, where a is a non-zero real number and b is any real number.

The positions of the through holes (2-43) can be set as needed. FIGS. 37 and 38 illustrate two different configurations of through holes (2-43) corresponding to the linear relationship.

When the resistance between the connection points of each electrode wire (2-431) on the potential distribution wire (2-45) and the first driving voltage loading position, and the distance between these connection points and the first driving voltage loading position in the second direction, exhibit a parabolic relationship, the electrode wires (2-431) can collectively form a parabolic cylindrical potential distribution in the surrounding space.

When the resistance between the connection points of each electrode wire (2-431) on the potential distribution wire (2-45) and the first driving voltage loading position, and the distance between these connection points and the first driving voltage loading position in the second direction, exhibit a linear relationship, the electrode wires (2-431) can collectively form a conical potential distribution in the surrounding space.

In this embodiment, the potential distribution wire (2-45) is a uniformly wide potential distribution wire (2-45). The length of the potential distribution wire (2-45) between the connection points of each electrode wire (2-431) and the first driving voltage loading position is in a parabolic or linear relationship with the distance between these connection points and the first driving voltage loading position in the second direction.

By employing a uniformly wide potential distribution wire (2-45), the resistance of each section of the potential distribution wire (2-45) is proportional to its length. Therefore, by controlling the length of the potential distribution wire (2-45) between the connection points of the electrode wires (2-431) and the potential distribution wire (2-45), the electrode unit (2-41) can precisely control the potential to achieve a parabolic cylindrical or conical potential distribution.

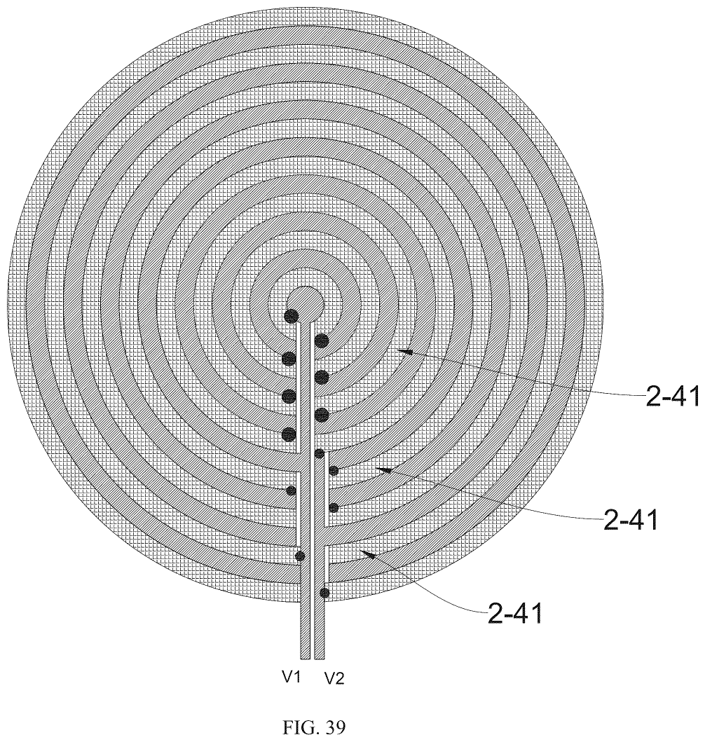

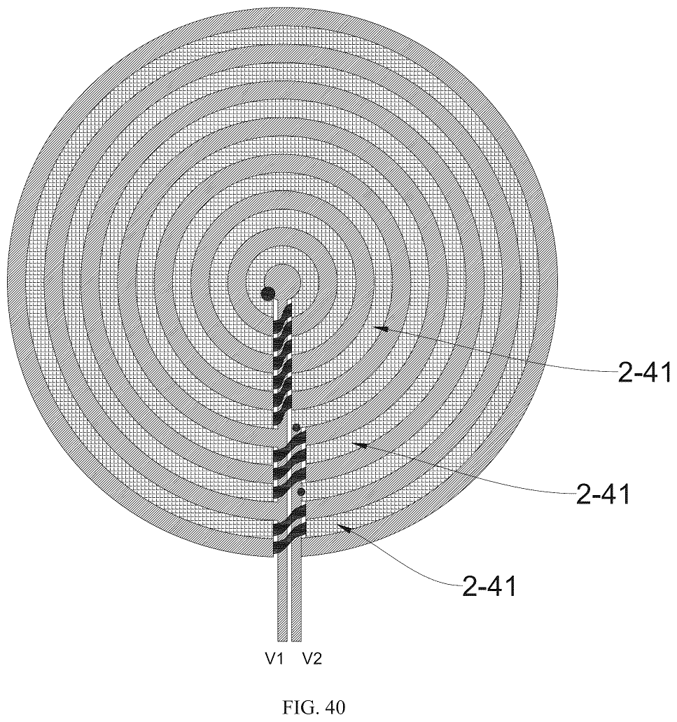

To achieve a large-aperture liquid crystal lens and reduce the voltage difference between the driving voltages, as shown in FIGS. 39 to 40, the liquid crystal optical device in this embodiment can be configured as a liquid crystal Fresnel lens. As an optional but advantageous implementation, in this embodiment, the second electrode layer (2-4) includes multiple electrode units (2-41) arranged sequentially from the center to the edge of the second electrode layer (2-4). Under the driving action of the first and second driving voltages, each electrode unit (2-41) induces deflection of the liquid crystals in the liquid crystal layer, forming a liquid crystal Fresnel lens. Each electrode unit (2-41) may adopt the aforementioned structure with concentric arc segments (2-44).

Each electrode unit (2-41) controls the deflection of the liquid crystal material in a corresponding annular region, ensuring that the phase delay effect of the deflected liquid crystal on the transmitted light matches that of a corresponding annular band of a Fresnel lens. With the combined action of all electrode units (2-41), the deflected liquid crystal material forms a liquid crystal Fresnel lens. The liquid crystal Fresnel lens formed by this structure not only achieves high precision in potential distribution but also effectively eliminates diffraction phenomena.

Additionally, as shown in FIG. 41, this embodiment can also realize a liquid crystal Fresnel cylindrical lens. For this purpose, the second electrode layer (2-4) comprises multiple electrode units (2-41) arranged along the first direction. Under the driving action of the first and second driving voltages, each electrode unit (2-41) induces deflection of the liquid crystals in the liquid crystal layer, forming a liquid crystal Fresnel cylindrical lens. Each electrode unit (2-41) may adopt the aforementioned structure with a potential distribution wire (2-45) and the first electrode.

The liquid crystal Fresnel cylindrical lens formed by this structure not only achieves high precision in potential distribution but also effectively eliminates diffraction phenomena.

In this embodiment, a high-impedance film, high-dielectric-constant layer, or potential buffer layer can be provided on the side of the first electrode unit facing the insulating layer or on the side of the first electrode unit opposite the insulating layer. Similarly, a high-impedance film, high-dielectric-constant layer, or potential buffer layer can be provided on the side of the second electrode unit facing the insulating layer or on the side of the second electrode unit opposite the insulating layer.

By incorporating the aforementioned high-impedance film, high-dielectric-constant layer, or potential buffer layer into the liquid crystal lens, the potential distribution between adjacent portions of the first and/or second electrode units can be made significantly smoother.

In this embodiment, the first electrode layer (2-2) may be implemented as a planar electrode.

To facilitate the application of driving voltages, the liquid crystal optical device in this embodiment further includes a first electrode lead and a second electrode lead. The first electrode lead is connected to the first driving voltage loading position, while the second electrode lead is connected to the second driving voltage loading position. The first driving voltage is applied to the first driving voltage loading position of the electrode unit (41) through the first electrode lead, and the second driving voltage is applied to the second driving voltage loading position of the electrode unit (41) through the second electrode lead.

In specific implementations, the first electrode lead and/or the second electrode lead may be located in the same layer as the first segment (411) or the second segment (412). In this case, the electrode pattern of the electrode unit (41) should provide routing spaces for the first and second electrode leads.

As an example, the liquid crystal optical device in this embodiment further includes a second insulating layer. One end of the first electrode lead is exposed outside the second insulating layer and connected to the electrode unit (41), while the rest of the first electrode lead is separated from the electrode unit (41) by the second insulating layer. Similarly, one end of the second electrode lead is exposed outside the second insulating layer and connected to the electrode unit (41), while the rest of the second electrode lead is separated from the electrode unit (41) by the second insulating layer.

In this embodiment, the second insulating layer isolates the first and/or second electrode leads from the electrode unit (41), leaving only the ends of the leads connected to the two driving voltage loading positions. This eliminates the need for the electrode pattern of the electrode unit (41) to allocate specific positions for the electrode leads, thereby further improving the precision of potential distribution control.

### Example 3

The embodiment provides an electronic product, which includes a control circuit and the liquid crystal optical device described in Example 1 and Example 2. The control circuit is electrically connected to the liquid crystal optical device. The electronic product includes, but is not limited to, imaging devices, display devices, mobile phones, AR devices, VR devices, autostereoscopic 3D products, wearable devices, and the like.

The above descriptions are merely specific embodiments of the present invention. Those skilled in the art can clearly understand that, for convenience and brevity of description, the specific operational processes of the systems, modules, and units described above can refer to the corresponding processes in the method embodiments, and are not reiterated here. It should be understood that the scope of protection of the present invention is not limited to this, and any modifications or substitutions that those skilled in the art can easily think of within the technical scope disclosed in the present invention should be included in the scope of protection of the present invention.

What is claimed is:

1. A liquid crystal optical device, wherein it comprises a first substrate, a first electrode layer, a liquid crystal layer, a second electrode layer, and a second substrate sequentially stacked;
the second electrode layer comprises an insulating layer, a first electrode structure, and a second electrode structure, one of the first electrode structure and the second electrode structure is located on a side of the insulating layer facing the liquid crystal layer, and the other is located on a side of the insulating layer away from the liquid crystal layer, a projection of the second electrode structure onto a plane wherein the first electrode structure located covers gaps in the first electrode structure.

2. The liquid crystal optical device as defined in claim 1, wherein the first electrode structure is provided with a first driving voltage loading position and a second driving voltage loading position, the first driving voltage loading position is configured to receive a first driving voltage, and the second driving voltage loading position is configured to receive a second driving voltage, with the first driving voltage being different from the second driving voltage; the second electrode structure is provided with a third driving voltage loading position and a fourth driving voltage loading position, the third driving voltage loading position is configured to receive a third driving voltage, and the fourth driving voltage loading position is configured to receive a fourth driving voltage, with the third driving voltage being different from the fourth driving voltage.

3. The liquid crystal optical device as defined in claim 2, wherein the first electrode structure comprises at least two segments, with gaps between at least part of adjacent segments of the first electrode structure;
the second electrode structure comprises at least two segments, with gaps between at least part of adjacent segments of the second electrode structure;
the projection of the second electrode structure onto the plane where the first electrode structure is located fully or partially covers the gaps between adjacent segments of the first electrode structure;
the projection of the first electrode structure onto a plane wherein the second electrode structure is located fully or partially covers the gaps between adjacent segments of the second electrode structure;
the first electrode layer is provided with a third electrode structure.

4. The liquid crystal optical device as defined in claim 2, wherein the projection of the first electrode structure onto the plane where the second electrode structure is located coincides with the gaps between adjacent segments of the second electrode structure.

5. The liquid crystal optical device as defined in claim 4, wherein the first electrode structure includes a first electrode wire extending from a central position of the second electrode layer towards an edge of the second electrode layer; one end of the first electrode wire is configured to receive the first driving voltage, while the opposite end is configured to receive the second driving voltage;
the second electrode structure includes a second electrode wire extending from a central position of the second electrode layer towards an edge of the second electrode layer; one end of the second electrode wire is configured to receive the third driving voltage, while the opposite end is configured to receive the fourth driving voltage.

6. The liquid crystal optical device as defined in claim 2, wherein the first electrode wire includes several concentric arc segments with different radii, and each concentric arc segment in the first electrode wire serves as a segment of the first electrode structure, gaps are provided between adjacent concentric arc segments in the first electrode wire, and the adjacent concentric arc segments in the first electrode wire are connected by linking segments
the second electrode wire includes several concentric arc segments with different radii, and each concentric arc segment in the second electrode wire serves as a segment of the second electrode structure, gaps are provided between adjacent concentric arc segments in the second electrode wire, and the adjacent concentric arc segments in the second electrode wire are connected by linking segments.

7. The liquid crystal lens as defined in claim 1, wherein the first electrode structure includes a first potential distribution wire and several third electrode wires, each third electrode wire serves as one segment of the first electrode structure, the third electrode wires are linear in shape, and all the third electrode wires are parallel to a first direction, the first driving voltage loading position and the second driving voltage loading position are located on the first potential distribution wire, one end of each third electrode wire is connected to the first potential distribution wire, while the opposite end is suspended;
connection positions of the third electrode wires to the first potential distribution wire between the first driving voltage loading position and the second driving voltage loading position, connection positions of the different third electrode wires to the first potential distribution wire are different;
the second electrode structure includes a second potential distribution wire and several fourth electrode wires, each fourth electrode wire serves as one segment of the second electrode structure, the fourth electrode wires are linear in shape, and all the fourth electrode wires are parallel to the first direction, the third driving voltage loading position and the fourth driving voltage loading position are located on the second potential distribution wire, one end of each fourth electrode wire is connected to the second potential distribution wire, while the opposite end is suspended;
the connection positions of the fourth electrode wires to the second potential distribution wire are between the third driving voltage loading position and the fourth driving voltage loading position, the connection positions of the different fourth electrode wires to the second potential distribution wire are different, a projection of the fourth electrode wire onto the plane where the third electrode wire is located covers the gap between adjacent third electrode wires, and the projection of the third electrode wire onto the plane where the fourth electrode wire is located covers the gap between adjacent fourth electrode wires.

8. The liquid crystal optical device as defined in claim 2, wherein the first electrode structure includes a third potential distribution wire and several concentric arc electrode wires, each concentric arc electrode wire of the first electrode structure serves as one segment of the first electrode structure, the third potential distribution wire extends from a center of the liquid crystal lens towards an edge of the liquid crystal lens, two opposite ends of the third potential distribution wire are the first driving voltage loading position and the second driving voltage loading position, respectively; the second electrode structure includes a fourth potential distribution wire and several concentric arc electrode wires, each concentric arc electrode wire of the second electrode structure serves as a segment of the second electrode structure, the fourth potential distribution wire extends from the center of the liquid crystal lens towards the edge of the liquid crystal lens, two opposite ends of the fourth potential distribution wire are the third driving voltage loading position and the fourth driving voltage loading position, respectively.

9. The liquid crystal optical device as defined in claim 2, wherein the first electrode structure includes several first electrode units arranged sequentially from the center to the edge of the second electrode layer, each of the electrode units causing the molecules of the liquid crystal in the liquid crystal layer to rotate and form a liquid crystal Fresnel lens under driving of the first driving voltage and the second driving voltage;
the second electrode structure includes several first electrode units arranged sequentially from the center to the edge of the second electrode layer, each of the first electrode units causing the molecules of the liquid crystal in the liquid crystal layer to rotate and form a liquid crystal Fresnel lens under the drive of the third driving voltage and the fourth driving voltage.

10. The liquid crystal optical device as defined in claim 2, wherein the first electrode structure includes multiple second electrode units arranged along the first direction, each of the electrode units causing the liquid crystal in the liquid crystal layer to deflect and form a liquid crystal Fresnel cylindrical lens under driving of the first driving voltage and the second driving voltage;
the second electrode structure includes multiple second electrode units arranged along the first direction, each of the second electrode units causing the liquid crystal in the liquid crystal layer to deflect and form a liquid crystal Fresnel cylindrical lens under driving of the third driving voltage and the fourth driving voltage.

11. The liquid crystal optical device as defined in claim 1, wherein the insulating layer of the second electrode layer is a first insulating layer, the second electrode layer includes at least one electrode unit, which comprises the first electrode structure and the second electrode structure, the first electrode structure and the second electrode structure are located on opposite sides of the first insulating layer, the electrode unit is provided with a first driving voltage loading position and a second driving voltage loading position, the first driving voltage loading position is configured to receive a first driving voltage, and the second driving voltage loading position is configured to receive a second driving voltage, the first driving voltage and the second driving voltage are different, a projection of the first electrode structure onto a second reference plane covers the gap of the second electrode structure.

12. The liquid crystal optical device as defined in claim 11, wherein the first electrode structure includes at least two first segments, with gaps between at least part of adjacent first segments of the first electrode structure, the second electrode structure includes at least two second segments, with gaps between at least part of adjacent second segments of the second electrode structure, a projection of the second electrode structure onto a first reference plane at least partially covers the gaps between the adjacent first segments of the first electrode structure, and a projection of the first electrode structure onto a second reference plane at least partially covers the gaps between the adjacent second segments of the second electrode structure, the first reference plane is the upper or lower surface of the first electrode structure, and the second reference plane is the upper or lower surface of the second electrode structure; the first insulating layer is provided with a through hole passing through the first insulating layer, and a connecting part is provided in the through hole, the adjacent first segments and second segments are electrically connected through the connecting part.

13. The liquid crystal optical device as defined in claim 11, wherein the projection of the first electrode structure onto the second reference plane coincides with the gap between adjacent second segments.

14. The liquid crystal optical device as defined in claim 11, wherein the first electrode structure includes several concentric arc segments of different radii, each concentric arc segment of the first electrode structure serving as one of the first segments, and gaps being provided between adjacent concentric arc segments of the first electrode structure; the second electrode structure includes several concentric arc segments of different radii, each concentric arc segment of the second electrode structure serving as one of the second segments, and gaps being provided between adjacent concentric arc segments of the second electrode structure, the adjacent concentric arc segments of the first and second electrode structures are electrically connected through a connecting part;
the projection of the concentric arc segments belonging to the first electrode structure onto the second reference plane at least partially cover the gap between adjacent concentric arc segments of the second electrode structure;
the projection of the concentric arc segments belonging to the second electrode structure onto the first reference plane at least partially cover the gap between adjacent concentric arc segments of the first electrode structure.

15. The liquid crystal optical device as defined in claim 11, wherein the electrode unit includes a potential distribution wire and at least two electrode wires, one part of the potential distribution wire belongs to the first electrode structure and another part belonging to the second electrode structure, one part of the electrode wires belongs to the first electrode structure and the other part belongs to the second electrode structure, each electrode wire belonging to the first electrode structure serves as one of the first segments, and each electrode wire belonging to the second electrode structure serves as one of the second segments, the electrode wires are linear and parallel to the first direction, the first driving voltage loading position and the second driving voltage loading position are set on the potential distribution wire, and one end of the electrode wires is connected to the potential distribution wire, while the opposite end is suspended, connection positions of the electrode wires with the potential distribution wire are between the first driving voltage loading position and second driving voltage loading position, the connection positions of different electrode wires with the potential distribution wire are different;
the projection of the electrode wires belonging to the first electrode structure onto the second reference plane covers the gap between adjacent electrode wires belonging to the second electrode structure, while the projection of the electrode wires belonging to the second electrode structure onto the first reference plane covers the gap between adjacent electrode wires belonging to the first electrode structure.

16. The liquid crystal optical device as defined in claim 15, wherein resistance values between positions on the potential distribution wire where each electrode wire is connected and the first driving voltage loading position, and distances from the position on the second direction where each electrode wire is connected to the potential distribution wire to the first driving voltage loading position, follow a parabolic or linear relationship, wherein the second direction is perpendicular to the first direction.

17. The liquid crystal optical device as defined in claim 11, wherein the second electrode layer includes a plurality of electrode units arranged sequentially from the center to the edge of the second electrode layer, each of the electrode units driving the molecules of the liquid crystal in the liquid crystal layer to rotate and form a liquid crystal Fresnel lens under the driving of the first driving voltage and the second driving voltage.

18. The liquid crystal optical device as defined in claim 11, wherein the second electrode layer comprises multiple electrode units arranged along the first direction, each electrode unit, driven by the first driving voltage and the second driving voltage, causes the liquid crystal within the liquid crystal layer to deflect, forming a liquid crystal Fresnel cylindrical lens.

19. The liquid crystal optical device as defined in claim 11, further comprising a first electrode lead and a second electrode lead, wherein the first electrode lead is connected to the first driving voltage loading position of the electrode unit, and the second electrode lead is connected to the second driving voltage loading position of the electrode unit, the liquid crystal optical device further comprises a second insulating layer, one end of the first electrode lead is exposed outside the second insulating layer and connected to the electrode unit, while the remaining portion of the first electrode lead is separated from the electrode unit by the second insulating layer; and/or one end of the second electrode lead is exposed outside the second insulating layer and connected to the electrode unit, while the remaining portion of the second electrode lead is separated from the electrode unit by the second insulating layer.

20. An electronic product, comprising a control circuit and the liquid crystal optical device according to claim 1, wherein the control circuit is electrically connected to the liquid crystal optical device.
